(19) United States
(12) Patent Application Publication
(10) Pub. No.: US 2006/0003746 A1
(43) Pub. Date: Jan. 5, 2006

(54) Method and apparatus for providing network support for fax management via a mobile device

(76) Inventors: Sandra Lynn True, St. Charles, IL (US); David S. Benco, Winfield, IL (US); Kevin J. Overend, Elmhurst, IL (US); Baoling S. Sheen, Naperville, IL (US); Kenneth J. Voight, Sugar Grove, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(21) Appl. No.: 10/857,490

(22) Filed: May 28, 2004

(51) Int. Cl. H04Q 7/20

(52) U.S. Cl. 455/414.1; 455/432.3

(57) ABSTRACT

A method and apparatus for providing network support for fax management via a mobile device are provided. More particularly, the exemplary embodiments described relate to a technique that allows a mobile subscriber to manage incoming faxes by choosing, for example, to read, store, delete, forward, or print the fax at the time the fax call is received. In addition, the system allows a mobile subscriber to manage faxes that have already been stored on a network fax management system from a mobile handset by, for example, reading, printing, deleting, or forwarding the received faxes.

### BACKGROUND OF THE INVENTION

This invention relates to a method and apparatus for providing network support for facsimile (fax) management via a mobile device. More particularly, the exemplary embodiments described relate to a technique that allows a mobile subscriber to manage incoming faxes by choosing, for example, to read, store, delete, forward, or print the fax at the time the fax call is received. In addition, the system allows a mobile subscriber to manage faxes that have already been stored on a network fax management system from a mobile handset by, for example, reading, printing, deleting, or forwarding the received faxes.

While the invention is particularly directed to the art of mobile fax management, and will be thus described with specific reference thereto, it will be appreciated that the invention may have usefulness in other fields and applications. For example, the invention may be used in other situations where it would be desirable to manage electronic documents stored on a network from a mobile device.

By way of background, as wireless technologies increasingly penetrate the marketplace, many consumers are opting to discontinue existing landline telephone services and become exclusive wireless customers in the area of telecommunications. Consequently, there is a need to be able to perform many tasks on a wireless basis. Among these tasks is the ability to manage faxes (e.g. manage faxes from a mobile handset).

There are mobile fax devices known in the art. However, these mobile fax devices suffer from a number of deficiencies. For example, known mobile devices have limitations on memory capability which makes it impossible to keep, store, and manage multiple faxes. In addition, mobile phones do not have sufficient capability to be able to exclusively handle fax management. Currently, no network support is known to exist to assist in overcoming these deficiencies.

The present invention contemplates a new and improved network support system for fax management via a mobile device that resolves the above-referenced difficulties and others.

### SUMMARY OF THE INVENTION

A method and apparatus for providing network support for fax management via a mobile device are provided.

In one aspect of the invention, the method comprises receiving a call to a mobile device used by a mobile subscriber, recognizing the call as a fax call associated with a fax, determining if the mobile device is enabled to receive the fax call, sending the fax call to the mobile device, if the mobile device is enabled to receive the fax call, determining if the mobile device answers the fax call and providing the mobile device with a menu identifying a plurality of fax management options, if the mobile device is answered.

In another aspect of the invention, the method comprises receiving a call from the mobile device used by a mobile subscriber, recognizing the call as a fax management call, determining if the mobile subscriber associated with the mobile device is a valid subscriber and providing the mobile device with a menu identifying a plurality of fax management options.

In another aspect of the invention, the system or apparatus of the present invention comprises means to accomplish the methods of the present invention.

An advantage of the present invention is that storing and managing faxes is improved because memory and storage devices on the network are typically larger and more expandable.

Another advantage of the present invention is that subscribers have improved control over management of faxes.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a functional block diagram illustrating an exemplary implementation of the present invention;

FIG. 2 is a block diagram illustrating an example fax management system and related elements of FIG. 1;

FIG. 3 is a flow chart illustrating a method according to the present invention; and,

FIG. 4 is a flow chart illustrating a method according to the present invention.

### DETAILED DESCRIPTION OF THE PREFERRED EMBODIMENTS

Referring now to the drawings wherein the showings are for purposes of illustrating the preferred embodiments of the invention only and not for purposes of limiting same, FIG. 1 provides a view of an overall exemplary system according to the present invention and a network into which it is incorporated. As shown, a network 10 includes a mobile switching center (MSC) 12 that communicates through a base station 14 to a mobile device 16 associated with a mobile subscriber. A voicemail system 18 and a fax management system 20 are also in communication with the mobile switching center (MSC) 12. A subscriber database 22 is provided to the mobile switching center (MSC) 12 to make relevant subscriber data regarding subscriber profiles and available services accessible to the mobile switching center (MSC) 12. In addition, the mobile switching center (MSC) 12 is shown as being connected through a public switched telephone network (PSTN) 24 to another device such as a fax device 26 or the like.

In operation, the described embodiments of the present invention provide a plurality of functions when a fax is sent to a mobile device. For example, as the fax call is received, the present system allows the mobile subscriber to choose to receive the entire fax at the mobile device (if possible), choose to read only the fax header information (e.g., sending party, sending party's number, number of pages, title of fax), or choose to store the fax on the network fax management system 20. Of course, the mobile subscriber may also choose to delete the incoming fax, forward the incoming fax to another number, or choose to print the fax using its mobile device 16, provided that the mobile device or handset is also a mobile fax device. If the mobile subscriber is not available to receive the fax call and thus not available to decide the manner in which the call should be handled, the system preferably, by default, stores the fax in the network fax management system 20 for later processing by the mobile subscriber.

In addition, the presently described embodiments provide the mobile user with other capabilities. For example, the present system allows the mobile subscriber to interact with the network fax management system 20 from the mobile device 16 in order to manage faxes that have been stored on the network fax management system 20. Accordingly, the mobile subscriber may use the mobile device 16 to read new or stored faxes, print stored faxes, delete stored faxes, and forward stored faxes to another number.

To realize the functionality of the presently described embodiments of the invention, a variety of implementations may be used. The network shown in FIG. 1 is simply an example. It should be appreciated that the base station 14, public switched telephone network 24 and fax device 26 can take a variety of known forms—or may be replaced with other network components that provide similar functionality. It should also be understood that other components (such as computers having fax capability, other mobile devices, . . . etc.) may also be used in the system to utilize the functionality of the presently described embodiments. Still further modifications to the network of FIG. 1 may be implemented as a result of a different generation of wireless technology. For example, the mobile switching center (MSC) 12 may be replaced by a primary switching module of another form suited to different technology.

Likewise, the mobile device 16 can take the form of that which is known in the art. For example, it may be in the form of a wireless phone and/or a wireless fax machine. In any event, however, the mobile device 16 preferably has sufficient capability to store data, accept downloaded data and/or instructions from the network, display data, and provide sufficient interface capability to the network to realize the functionality of the present invention. Such capability is typically present in mobile phones presently manufactured.

The mobile switching center 12, subscriber database 22, and the voicemail system 18 may require modifications that will be apparent from this description. Moreover, the fax management system 20 is included within the system 10 in order to realize the invention.

For example, mobile switching center (MSC) 12 preferably is able to receive an incoming fax call, and recognize that call as a fax call by reading an appropriate bit in the message, for example. The mobile switching center (MSC) 12, under the present invention, preferably has the ability to accept the fax call and connect to the fax management system 20 to, among other functions, provide the mobile subscriber with options on how to handle incoming fax calls when answered. In this regard, the mobile switching center (MSC) 12 has the ability to communicate (e.g. handshake) with the fax device 26, for example, to complete the fax call, store the fax in the fax management system 20, and notify the mobile subscriber 16. This functionality of recognizing and completing the fax call is well known in fax technology and is implemented in the mobile switching center (MSC) 12 in this embodiment. It should be understood that this may also be implemented directly within the fax management system 20—in which case the mobile switching center (MSC) itself would only need to recognize a fax call and pass it on to the fax management system 20. The mobile switching center (MSC) 12 (or fax management system) is operative in this manner so that the fax device 26 will send the fax to the mobile switching center (MSC) 12 and be removed from the process. This, of course, allows for better fax management, because it can then be supported by the network.

As for the notification to the subscriber and the presentation of options to the subscriber, the mobile switching center (MSC) 12 is operative to first determine whether the mobile subscriber is a valid subscriber to the contemplated fax management service by accessing the subscriber database 22. In this regard, the subscriber database 22 will be supplemented with an additional field indicating fax management capability.

If the subscriber is a valid subscriber, the subscriber is presented with options/instructions from the fax management system 20 through the network that may require subscriber input. For example, the instructions may require the mobile subscriber to press “1” to read the fax header information only, press “2” to store the fax on the fax management system, . . . etc. The mobile switching center (MSC) 12 then collects the digits entered by the mobile subscriber and forwards them for processing to the fax management system 20. It should be understood that such processing may require further action of the mobile switching center (MSC) 12. For example, the mobile switching center (MSC) 12 may be further used to communicate with the mobile device 16 or may be used to initiate a call to another device (as in the case of call forwarding).

In addition, the mobile switching center (MSC) 12 is also operative to communicate with the mobile subscriber and preferably recognizes a subscriber call to the fax management system 29. Of course, the mobile switching center (MSC) 12 will preferably have the ability to validate that mobile subscriber via access to the subscriber database 22. If the mobile subscriber is not an authorized user, an error message will be played and the call will be ended. If, however, the subscriber is an authorized user, the mobile switching center (MSC) 12 will connect the mobile subscriber to the fax management system 20 so that an appropriate menu of options may be presented to the mobile subscriber thereby. For example, the mobile subscriber may be presented with the options of reading a new fax by pressing “1”, reading an old fax by pressing “2”, printing a fax by pressing “3”, deleting a fax by pressing “4”, forwarding a fax to another destination number by pressing “5”, or exiting by pressing “6”. In this regard, the mobile switching center (MSC) 12 collects the digits entered by the mobile subscriber and conveys them to the fax management system 20 so the appropriate functions can be performed. Again, it should be understood that such processing may require further action of the mobile switching center (MSC) 12. For example, the mobile switching center (MSC) 12 may be further used to communicate with the mobile device 16 or may be used to initiate a call to another device (as in the case of call forwarding).

The voicemail system 18 may be used by the present system as an option for providing notification to the mobile subscriber that a fax has been received. In this regard, the fax management system 20 or the mobile switching center (MSC) 12 may provide a recorded message to the voicemail inbox of the mobile subscriber upon receipt and storage of a fax.

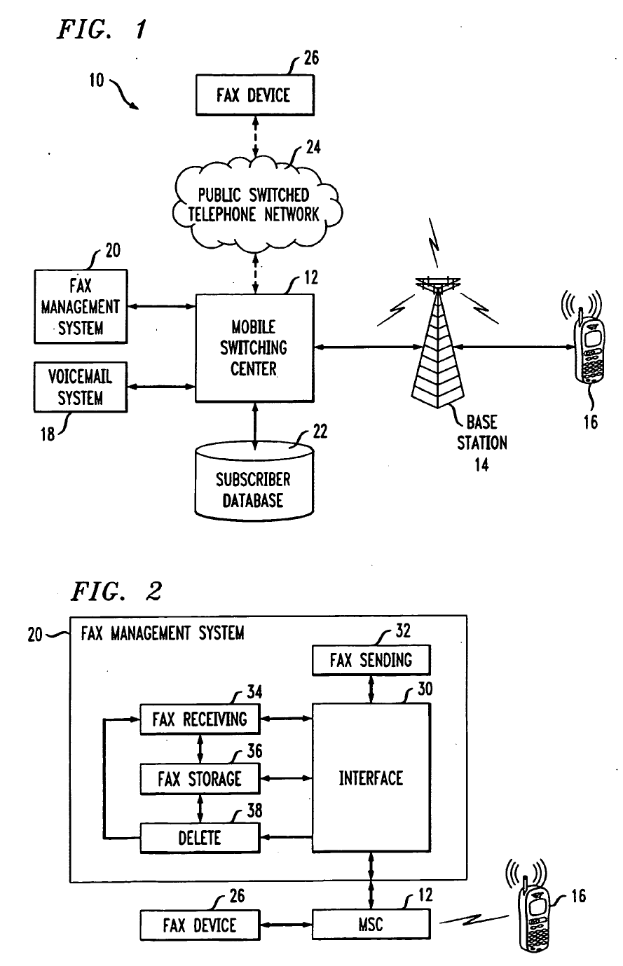

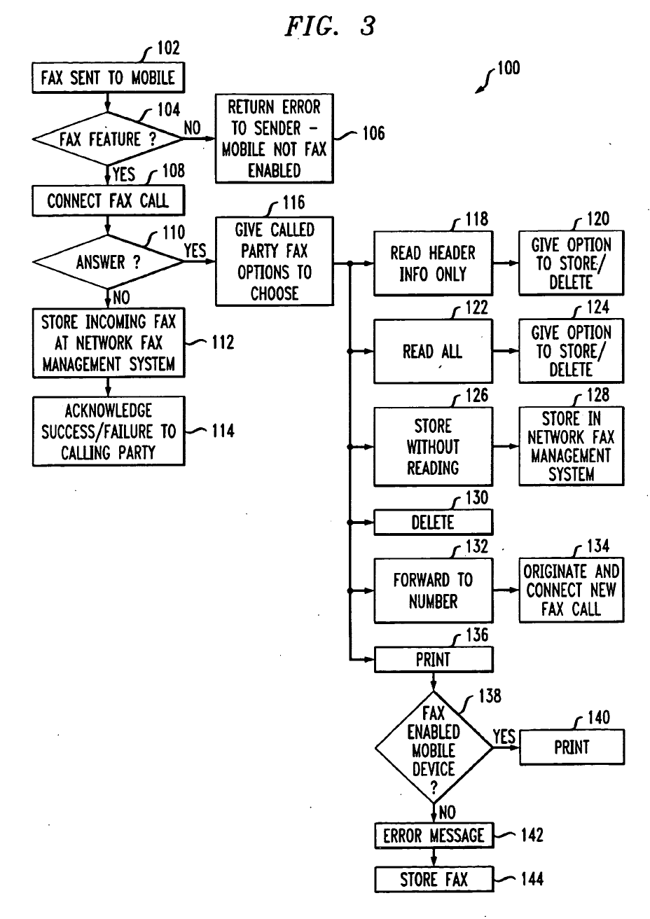

With reference to FIG. 2, the fax management system 20 is shown. The fax management system 20, which is in communication with the mobile switching center (MSC) 12 and, consequently and by example, the mobile device 16 and the fax device 26, includes an interface 30. The interface 30 communicates with a fax sending module 32, a fax receiving module 34, and a fax storage module 36. The fax storage module may store faxes in a variety of different data formats as may be appropriate; however, it is preferred that the faxes be stored in bitmap form so that it can be conveniently retrieved and downloaded for viewing. Of course, the interface allows the mobile subscriber 16, through the MSC 12, to send, receive, and store faxes. Also shown in FIG. 2 is a delete module 38 which allows appropriate deletion of faxes that are stored upon the command of the mobile user 16. Of course, as an alternative, the fax management system 20 may simply provide a time threshold to permit deletion of stored faxes upon expiration of a timer.

It should be appreciated that, although the mobile switching center 12, the subscriber database 22, the fax management system 20 and the voicemail system 18 are shown as separate components, such components, or some combination thereof, may well be incorporated with the same network element, such as a mobile switching center. For example, the fax management system 20 may be incorporated as a module within the mobile switching center 12.

Along these lines, the operation of the network elements illustrated in FIGS. 1 and 2 is supported by the elements shown, appropriate hardware, and appropriate software implementing the methods of the present invention. However, it should be understood that the method recited in connection with FIGS. 14 may well be embodied in software that is stored within the fax management system 20, the mobile switching center (MSC) 12, or distributed among those elements and/or others. For example, the software that controls the actions of the elements may be embodied in the interface 30 and the appropriate module of the mobile switching center (MSC) 12. If the fax management system 20 is primarily housed within the mobile switching center (MSC) 12, then the control software may reside in a single module.

With that in mind, FIG. 3 illustrates a method 100 according to exemplary embodiments of the present invention. The method 100 is initiated upon receipt by the mobile switching center (MSC) 12 of a fax sent to a mobile device 16 (at 102). Of course, as noted above, the mobile switching center (MSC) 12 recognizes the transmission and stores the incoming fax. However, before storing, it is first determined whether the mobile fax feature is enabled for the particular mobile subscriber, e.g. the mobile subscriber associated with the mobile device 16 (at 104). The mobile switching center (MSC) 12 determines if the mobile subscriber is an authorized user of the fax management system 20 by accessing the subscriber database 22. If not, an error message is returned to the sender (at 106). If, however, the fax feature is enabled for a particular subscriber, the fax call is connected and the fax is stored, at least temporarily, in, for example, fax receiving module 34 (at 108). A determination is then made as to whether the mobile subscriber answers the call (at 110). If not, the incoming fax is stored on the network fax management system 20 in the fax storage module 36 (at 112), and the acknowledgement of the success or failure of the call is provided to the sending party (at 114). If, however, the mobile subscriber answers the fax call, the fax management system 20, through the mobile switching center (MSC) 12, provides the called party with a menu of fax management options (at 116). The mobile subscriber then responds to the menu by entering digits which are recognized by the mobile switching center (MSC) 12 and passed on to the fax management system 20 through the interface 30.

As a result of the presentation of options, for example, the mobile subscriber may choose to read header information only (at 118). The subscriber is then given the option to store (or maintain) the fax in storage module 36 and/or delete the fax through delete module 38 (at 120). The mobile subscriber may select to read the entire fax (at 122) and then also be given the option to store and/or delete the fax, as above (at 124). The ability to read the fax will depend largely on the memory capacity of the mobile device 16. In this regard, sufficient memory space is required on the mobile device to accept a download of the fax, which is preferably stored in a bitmap form. In this regard, the ability to read the fax may also depend on the length of the fax. The mobile subscriber may choose to store the fax without reading it (at 126), in which case the fax is stored in the storage module 36 of the network fax management system 20 (at 128). The mobile subscriber may choose to delete the fax, through delete module 38 (at 130). The mobile subscriber may also select the option of forwarding the fax to a different number (at 132). In this case, the mobile switching center (MSC) 12 will originate and connect a new fax call to that number upon initiation by the fax sending module 32 (at 134). Last, the mobile subscriber may choose to print the fax (at 136). If so, a determination is made as to whether the mobile device, such as mobile device 16, is enabled to do so (at 138). If so, the fax is printed (at 140). If not, however, an error message is sent to the mobile subscriber (at 142) and the fax is simply stored in storage module 36 (at 144).

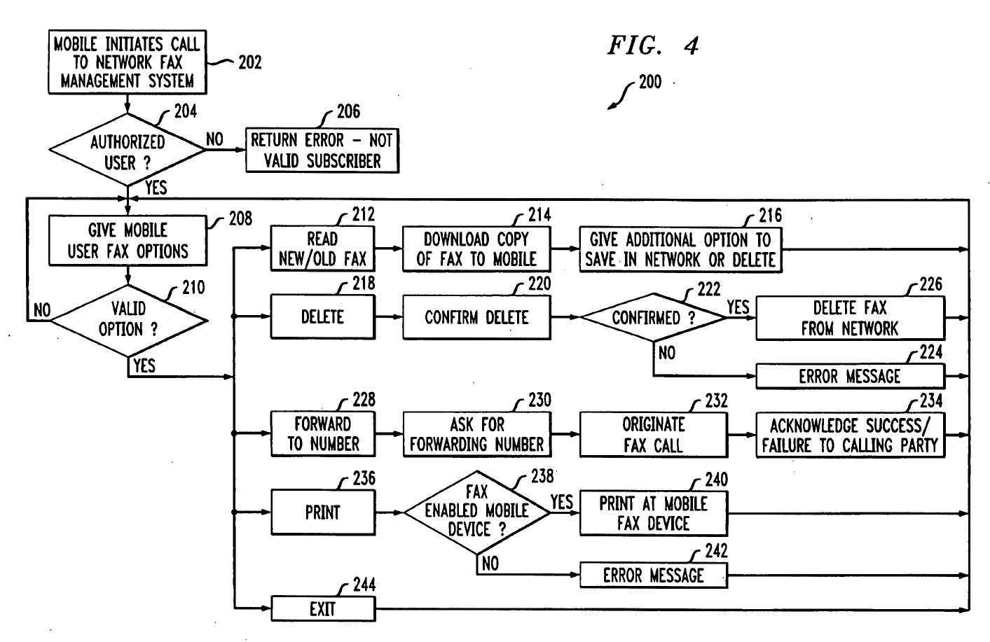

As noted above, the presently described fax management technique also allows for management of faxes that have been received and are stored. In this regard, FIG. 4 illustrates method 200 relating to fax management of stored faxes.

Initially, a mobile subscriber initiates a call directly to the fax management system (at 202). The mobile switching center (MSC) 12 determines if the mobile subscriber is an authorized user of the fax management system 20 by accessing the subscriber database 22 (at 204). If the mobile subscriber is not a valid subscriber, an error message is returned (at 206). However, if the mobile subscriber is a valid subscriber to the service, the fax management system 20, through the mobile switching center (MSC) 12, stores (at least temporarily) the fax in the fax receiving module 34 and then provides a menu of fax management options to the user (at 208).

A determination is made as to whether each of the options are valid based on the user subscription and the stored faxes (at 210). If the options are valid, the mobile subscriber then responds to the menu by entering digits which are recognized by the mobile switching center (MSC) 12 and passed on to the fax management system 20 through the interface 30. For example, the mobile subscriber may choose to read a new or old fax (at 212). In this case, a copy of the fax may be downloaded to the mobile device 16 (at 214). The ability to read the fax will depend largely on the memory capacity of the mobile device 16. In this regard, sufficient memory space is required on the mobile device to accept a download of the fax, which is preferably stored in a bitmap form. In this regard, the ability to read the fax may also depend on the length of the fax. Next, additional options are given to the user to save the fax in the storage module 36 or delete the fax through delete module 38 (at 216). The user may simply choose to delete a fax, through delete module 38 (at 218). In this case, the delete module 38, through the interface 30 and the mobile switching center 12, requests that the user confirm the deletion (at 220) and then determines if the deletion is so confirmed (at 222). If not, an error message is simply sent to the subscriber (at 224). However, if confirmation of the delete function is made by the user, the fax is deleted from the network (e.g., the fax storage module 36) (at 226). The user may also choose to forward a stored fax to a different number (at 228). The fax sending module 32 then requests the forwarding number (at 230). Upon initiation by the fax sending module 32, the mobile switching center (MSC) 12 then originates a fax call to the forwarding number and the fax is sent (at 232). An acknowledgement of the success or failure is provided to the calling party (at 234). The user may choose to print a stored fax from the storage module 36 (at 236). Of course, a determination is first made as to whether the mobile device 16 is fax enabled (at 238). If not, an error message is returned to the user (at 242). If, however, the mobile device 16 is a fax-enabled device, the fax is printed (at 240). The last option available to the user is that of exiting (at 244).

It should be appreciated that upon completion of each of these options, the user is presented with the menu. This will allow the subscriber to exercise a number of the options in connection with a single fax or exercise one or many options in connection with multiple faxes. For example, the subscriber may first decide to read a fax and then later print that same fax. Of course, the subscriber will ultimately need to exit the program, which constitutes another option.

In addition, it should be understood that the subscriber may also be provided with the opportunity to set preferences and create a subscriber profile. This profile may then be accessed by the fax management system or the mobile switching center to implement available functionality. For example, a subscriber may wish to forego notification and simply have all faxes directly stored. As a further example, a subscriber may wish to set a time threshold on storage of faxes.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for managing facsimile transmissions to a mobile device, the method comprising:
receiving a call to a mobile device used by a mobile subscriber;
recognizing the call as a fax call associated with a fax;
determining if the mobile device is enabled to receive the fax call;
sending the fax call to the mobile device, if the mobile device is enabled to receive the fax call;
determining if the mobile device answers the fax call; and,
providing the mobile device with a menu identifying a plurality of fax management options, if the mobile device is answered.

2. The method as set forth in claim 1 further comprising storing the fax.

3. The method as set forth in claim 1 wherein the plurality of fax management options include an option to read only header information of the fax.

4. The method as set forth in claim 1 wherein the plurality of fax management options include an option to read the fax.

5. The method as set forth in claim 4 further comprising downloading the stored fax.

6. The method as set forth in claim 1 wherein the plurality of fax management options include storing the fax.

7. The method as set forth in claim 1 wherein the plurality of fax management options includes deleting the fax.

8. The method as set forth in claim 1 wherein the plurality of fax management options includes forwarding the fax to another number.

9. The method as set forth in claim 1 wherein the plurality of fax management options includes printing the fax.

10. The method as set forth in claim 1 further comprising storing the fax if the mobile device is not answered.

11. A fax management system comprising:
means for receiving a call to a mobile device used by a mobile subscriber;
means for recognizing the call as a fax call associated with a fax;
means for determining if the mobile device is enabled to receive the fax call;
means for sending the fax call to the mobile device, if the mobile device is enabled to receive the fax call;
means for determining if the mobile device answers the fax call; and,
means for providing the mobile device with a menu identifying a plurality of fax management options, if the mobile device is answered.

12. A method for managing stored facsimile transmissions by a mobile device, the method comprising:
receiving a call from the mobile device used by a mobile subscriber;
recognizing the call as a fax management call;
determining if the mobile subscriber associated with the mobile device is a valid subscriber; and,
providing the mobile device with a menu identifying a plurality of fax management options.

13. The method as set forth in claim 12 wherein the plurality of fax management options include an option to read a stored fax.

14. The method as set forth in claim 13 further comprising downloading the stored fax.

15. The method as set forth in claim 14 further comprising restoring the previously stored fax.

16. The method as set forth in claim 11 wherein the plurality of fax management options includes deleting a stored fax.

17. The method as set forth in claim 1 wherein the plurality of fax management options includes forwarding a stored fax to another number.

18. The method as set forth in claim 1 wherein the plurality of fax management options includes printing a stored fax.

19. A fax management system comprising:
means for receiving a call from a mobile device used by a mobile subscriber;
means for recognizing the call as a fax management call;
means for determining if the mobile subscriber associated with the mobile device is a valid subscriber; and,
means for providing the mobile device with a menu identifying a plurality of fax management options, if the mobile subscriber is valid.
